(19) United States
(12) Patent Application Publication
(10) Pub. No.: US 2015/0133072 A1
(43) Pub. Date: May 14, 2015

(54) SELF-DEFENSE SPRAY AND METHOD OF CONTROLLING ELECTRONIC DEVICE USING THE SAME

(71) Applicant: DEIMOS DEFENCE INC., Seoul (KR)

(72) Inventors: SeWon JANG, Seoul (KR); HyunMin Lee, Seoul (KR); InSeong Cho, Gyeonggi-do (KR)

(73) Assignee: DEIMOS DEFENCE INC., Seoul (KR)

(21) Appl. No.: 14/142,506

(22) Filed: Dec. 27, 2013

(30) Foreign Application Priority Data
Nov. 11, 2013 (KR) 10-2013-0136088

(51) Int. Cl. H04M 1/725; H04N 5/232; H04N 1/00; F41H 9/10

(52) U.S. Cl. CPC H04M 1/72536; F41H 9/10; H04M 1/72527; H04N 5/23203; H04N 1/00244
USPC 455/404.1; 222/192; 455/556.1; 455/418

(57) ABSTRACT

There is provided a self-defense spray. The self-defense spray an audio terminal that transmits at least one signal to an electronic device capable of taking a photograph, and is connectable to the electronic device; a connecting portion connected to a container storing a liquid; a nozzle that sprays a liquid material from the container; and a button that simultaneously controls the nozzle so that the nozzle sprays the liquid material, and transmits a signal for taking a photograph to the electronic device through the audio terminal in response to being triggered. The invention can provide a self-defense spray which may be carried all the time, functions without a separate battery, and is effective in crime prevention by photographing a criminal, and a method of controlling an electronic device using the self-defense spray.

### CROSS-REFERENCE TO RELATED APPLICATIONS

This application claims the priority of Korean Patent Application No. 2013-0136088 filed on Nov. 11, 2013, in the Korean Intellectual Property Office, the disclosure of which is incorporated herein by reference.

### BACKGROUND OF THE INVENTION

1. Field of the Invention

The present invention relates to a self-defense spray, and a method of controlling an electronic device using the self-defense spray, more specifically, relates to a self-defense spray capable of interacting with a smart phone, and a method using the self-defense spray.

2. Description of the Related Art

A demand for a self-defense gadget is increasing as an anxiety regarding sex crimes against women is growing. A type of self-defense gadget is broadly divided into a whistle, a self-defense spray, a gas gun, an electronic shock machine, and the like. Among the self-defense gadgets, the self-defense spray, the spray, an alarm bell, and the like are products that may be used without an approval of use, and the gas gun and the electronic shock machine are products that may be used after obtaining an approval of use in advance. A reason for obtaining an approval of use in advance is to prepare for a case in which a product is misused for new crimes. Therefore, the product is supplied to a person positively identified through an identification check.

The self-defense spray has a lot of merits and thus, is frequently used among the products that may be used without an approval of use. The self-defense spray is convenient to carry, and operates in response to pressing a spraying button and thus, is easily used.

The self-defense spray contains capsaicin liquid which is included in mustard, a chili pepper, and the like. A small amount of the capsaicin liquid on a face is effective to cause eyes to burn to be unable to open. Therefore, when the capsaicin liquid is sprayed on a criminal, it is possible to deter the criminal from taking a second action since a clear view may not be secured.

### SUMMARY OF THE INVENTION

Therefore, an object of the present invention provides a self-defense spray which may be carried all the time, functions without a separate battery, and is effective in crime prevention by photographing a criminal, and a method of controlling an electronic device using the self-defense spray.

An object of the present invention also provides a self-defense spray which may immediately report a danger of a user through a network of emergency contacts, rapidly share a photo of a criminal, and collect data used to analyze a crime-ridden district, and a method of controlling an electronic device using the self-defense spray.

The objects of the present invention are not limited to the aforementioned objects, and other objects, which are not mentioned above, will be apparent to those skilled in the art from the following description.

In order to obtain the above described object, the self-defense spray according to an exemplary embodiment of the present invention includes an audio terminal that transmits at least one signal to an electronic device capable of taking a photograph, and is connectable to the electronic device; a connecting portion connected to a container storing a liquid; a nozzle that sprays a liquid material from the container; and a button that simultaneously controls the nozzle so that the nozzle sprays the liquid material, and transmits a signal for taking a photograph to the electronic device through the audio terminal in response to being triggered.

According to another characteristic of the present invention, the button is formed on an opposite side of a position where the audio terminal is formed.

According to still another characteristic of the present invention, the self-defense spray further includes a housing configured such that a spray direction of the nozzle matches a direction in which the electronic device takes a photograph.

According to still another characteristic of the present invention, the at least one signal is a function channel signal.

According to still another characteristic of the present invention, the self-defense spray further includes an input terminal that connects a separate audio terminal to the electronic device.

In order to obtain the above described object, the method of controlling an electronic device according to an exemplary embodiment of the present invention, which is connected to a self-defense spray, and includes a camera, in which the method includes receiving a function signal through an audio terminal of the self-defense spray; and operating the camera so that the camera takes a photograph in response to the function signal, and the operating of the camera is performed even when the electronic device is in a standby state.

According to another characteristic of the present invention, the method further includes transmitting information indicating that the self-defense spray is operated to a network of emergency contacts in response to the signal while operating the camera.

According to still another characteristic of the present invention, the method further includes transmitting the taken photograph to the network of emergency contacts.

According to still another characteristic of the present invention, the method further includes transmitting, to a server, the photograph, information of a location where the photograph is taken, and information of a time when the photograph is taken.

According to embodiments of the invention, at least the following effects are obtained.

That is, it is possible to provide a self-defense spray which may be carried all the time, functions without a separate battery, and is effective in crime prevention by photographing a criminal, and a method of controlling an electronic device using the self-defense spray.

In addition, it is possible to provide a self-defense spray which may immediately report a danger of a user through a network of emergency contacts, rapidly share a photo of a criminal, and collect data used to analyze a crime-ridden district, and a method of controlling an electronic device using the self-defense spray.

The effects of the present invention are not limited to the aforementioned effects, and more varied effects are included in the specification.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic diagram illustrating a self-defense spray according to an exemplary embodiment of the present invention;

FIGS. 1B and 1C are schematic diagrams illustrating that the self-defense spray according to the exemplary embodiment of the present invention is coupled with an electronic device;

FIG. 2 is a schematic diagram illustrating a case in which the electronic device coupled with the self-defense spray according to the exemplary embodiment of the present invention is operated;

FIG. 3 is a block diagram of the self-defense spray according to the exemplary embodiment of the present invention;

FIG. 4 is a schematic diagram illustrating a self-defense spray according to another exemplary embodiment of the present invention, and a container coupled with the self-defense spray;

FIG. 5 is a schematic diagram illustrating that an electronic device using a self-defense spray according to various exemplary embodiments of the present invention performs various functions through a communication network; and

FIG. 6 is a flowchart illustrating a method of controlling the electronic device using the self-defense spray according to the exemplary embodiment of the present invention.

### DETAILED DESCRIPTION OF THE PREFERRED EMBODIMENT

Various advantages and features of the present invention and methods accomplishing thereof will become apparent from the following description of embodiments with reference to the accompanying drawings. However, the present invention is not limited to exemplary embodiment disclosed herein but will be implemented in various forms. The exemplary embodiments are provided by way of example only so that a person of ordinary skilled in the art can fully understand the disclosures of the present invention and the scope of the present invention. Therefore, the present invention will be defined only by the scope of the appended claims.

Although first, second, and the like are used in order to describe various components, the components are not limited by the terms. The above terms are used only to discriminate one component from the other component. Therefore, a first component mentioned below may be a second component within the technical spirit of the present invention.

The same reference numerals indicate the same elements throughout the specification.

Respective features of various exemplary embodiments of the present invention can be partially or totally joined or combined with each other and as sufficiently appreciated by those skilled in the art, various interworking or driving can be technologically achieved and the respective exemplary embodiments may be executed independently from each other or together executed through an association relationship.

For the specification, when any one element transmits data or signal to other elements, it means that the elements can directly transmit the data or signal to other elements or can transmit the data or signal to other elements through another element.

In the specification, an electronic device may correspond to a device or a terminal including at least a microprocessor, a memory, and a communication module, and may correspond to a portable mobile terminal. When the electronic device corresponds to the mobile terminal, examples of the portable mobile terminal include a mobile phone, a smart phone, a notebook computer, a digital broadcasting terminal, personal digital assistants (PDA), a portable multimedia player (PMP), navigation equipment, and the like or an attachment used by being coupled with the devices. The electronic device is preferably a portable electronic device, and is more preferably a smart phone excellent in portability. Hereinafter, description is made on the assumption that the electronic device corresponds to a smart phone. However, the electronic device is not limited thereto, and may be one of the terminals mentioned above.

Hereinafter, various exemplary embodiments of the present invention are described in detail with reference to the accompanying drawings.

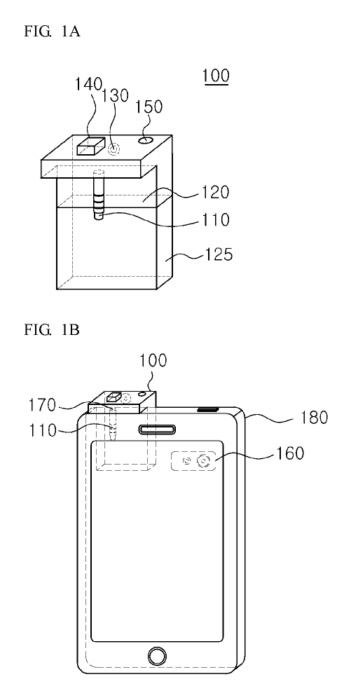

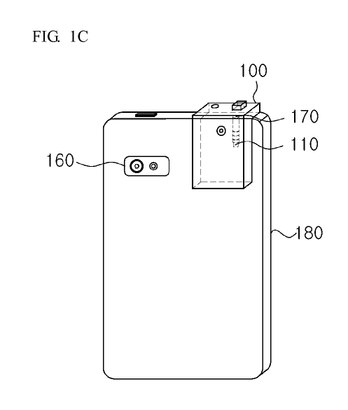

FIG. 1A is a schematic diagram illustrating a self-defense spray according to an exemplary embodiment of the present invention.

A self-defense spray 100 according to an exemplary embodiment of the present invention is a device used to spray a liquid material on a criminal who may threaten a user, and photograph the criminal using a photographing unit of an electronic device by transmitting a camera photographing signal to the electronic device connected to the self-defense spray 100. In addition, the electronic device connected to the self-defense spray 100 is configured to use a photo of the criminal in various facets. FIG. 1A illustrates the self-defense spray 100 connectable to the electronic device.

The self-defense spray 100 includes an audio terminal 110, a connecting portion, a container 125, a nozzle 130, a button 140, and an input terminal 150.

FIG. 1A illustrates the audio terminal 110 protruding from a lower surface of a body of the self-defense spray 100. In the self-defense spray 100 according to the exemplary embodiment of the present invention, the audio terminal 110 is used to transmit a control signal including a camera photographing signal to the electronic device. The audio terminal 110 may have a diameter of 3.5 mm, or have a diameter of 2.5 mm.

The audio terminal 110 is configured to have 3 poles or 4 poles. A plurality of poles are separated from each other by an insulator in the audio terminal 110, the audio terminal 110 may transmit three or four signals. In a case of the 4-pole audio terminal 110, the audio terminal 110 includes a left channel, a right channel, a ground (GND), and a function channel. The function channel is configured to transmit a plurality of signals by connecting resistors having different magnitudes in parallel. For example, when a first button 140 having a switching function in the function channel is pressed, the audio terminal 110 transmits a signal without using a separate resistor. In addition, the audio terminal 110 transmits a signal through a resistor when a second button 140 is pressed, and transmits a signal through another resistor when a third button 140 is pressed. The function channel of the audio terminal 110 uses the button 140 of FIG. 1 as a configuration for switching.

FIG. 1A illustrates the button 140 formed on an upper surface of the body of the self-defense spray 100. The button 140 is formed on an opposite side of a position where the audio terminal 110 is formed. The button 140 is a switch generating a signal from the audio terminal 110, and is a button applying a physical force so that a liquid material is sprayed through the nozzle 130. When the button 140 is pressed to deliver a sufficient pressure to spray a liquid material, the button 140 functions as a switch of a circuit so that the audio terminal 110 transmits a signal. The button 140 is configured to apply a sufficient pressure to spray a liquid material through the nozzle 130. In addition, the button 140 includes a suction pipe extending into the container 125 so that an end is connected to the button 140, and the other end suctions a liquid material contained in the container 125.

In the spray according to the exemplary embodiment of the present invention, the button 140 is a valve in a physical sense, and is a switch in an electrical sense. When the self-defense spray 100 is used, a user is in an urgency situation. Thus, the user simultaneously threatens a criminal and asks someone for help. However, it is difficult to simultaneously threaten a criminal and ask someone for help at a time. For example, the button 140 according to the exemplary embodiment of the present invention is a button used to simultaneously spray capsaicin liquid, and transmit a signal capable of asking someone for help. It should be noted that it is possible to simultaneously threaten a criminal and ask someone for help through the button 140 in an urgency situation.

In the self-defense spray 100 according to the exemplary embodiment of the present invention, it should be understood that it is significantly advantageous to transmit a signal to the electronic device through the button 140 and the audio terminal 110 when compared to a case of transmitting a signal to the electronic device through another connection means. For example, the self-defense spray 100 according to the exemplary embodiment of the present invention is described in comparison to a case of being connected through Bluetooth of other near field communication means. Bluetooth and the like use a pairing and thus, have an unstable connection, and depend on a battery. In addition, a cost of a Bluetooth module is higher than 20 times a cost of a switching of the audio terminal 110. Further, when the self-defense spray 100 is connected to a radio module such as a Bluetooth module, a direction of spraying by the self-defense spray 100 is not the same as a direction of photographing.

Accordingly, a configuration in which the self-defense spray 100 according to the exemplary embodiment of the present invention is connected to the electronic device through the audio terminal 110, and operates a camera by transmitting a signal to the electronic device is different from a configuration using near field communication such as a Bluetooth module.

Referring to FIG. 1A, the nozzle 130 is formed on a front surface of the body of the self-defense spray 100. The nozzle 130 corresponds to a configuration for spraying a liquid material outward from the container 125 in response to the button 140 pressed. The liquid material is mixed with air at an outlet of the nozzle 130. The nozzle 130 may spray a liquid material in a spraying form. The nozzle 130 is coupled with the container 125 through a container connecting portion 120, and sprays a liquid material by discharging the liquid material outward. The nozzle 130 may include a stopper disposed to wrap the nozzle 130. Herein, the nozzle 130 may be implemented according to a known configuration and operating method for spraying by a spraying device. Thus, detailed description thereof is omitted.

The container 125 is provided as a general molded article of metal or a synthetic resin, and includes an opening that receives a liquid material on an upper part thereof. The container connecting portion 120 receives the opening of the container 125, and is connected to the nozzle 130 and the button 140 to discharge a liquid material inside the container 125 outward through the nozzle 130 in response to the button 140 pressed.

The input terminal 150 is formed on the upper surface of the body of the self-defense spray 100. The input terminal 150 is a terminal connecting the electronic device, earphones, and the like. The audio terminal 110 of the self-defense spray 100 uses a connection terminal that connects the earphones and the like of the electronic device. Therefore, when the input terminal 150 is absent, the earphones and the like may not be connected through the electronic device. The input terminal 150 enables a user to listen to an audio by connecting the earphones and the like even when the self-defense spray 100 is connected to the electronic device.

FIGS. 1B and 1C are schematic diagrams illustrating that the self-defense spray 100 according to the exemplary embodiment of the present invention is coupled with the electronic device. FIG. 1B illustrates a front surface of an electronic device 180 coupled with a self-defense spray. FIG. 1C illustrates a rear surface of the electronic device 180 coupled with the self-defense spray.

In FIGS. 1B and 1C, the self-defense spray is connected to the electronic device 180 through the audio terminal 110 of the self-defense spray and an audio input terminal 170 of the electronic device 180. A housing of the self-defense spray is configured such that the nozzle 130 of the self-defense spray and a camera 160 of the electronic device 180 face in the same direction when the self-defense spray is connected to the electronic device 180. When the nozzle 130 and the camera 160 of the electronic device 180 face in the same direction, and the self-defense spray is operated, a user may simultaneously spray a liquid material on a criminal and photograph the criminal using the camera 160 by pressing the button 160 a single time.

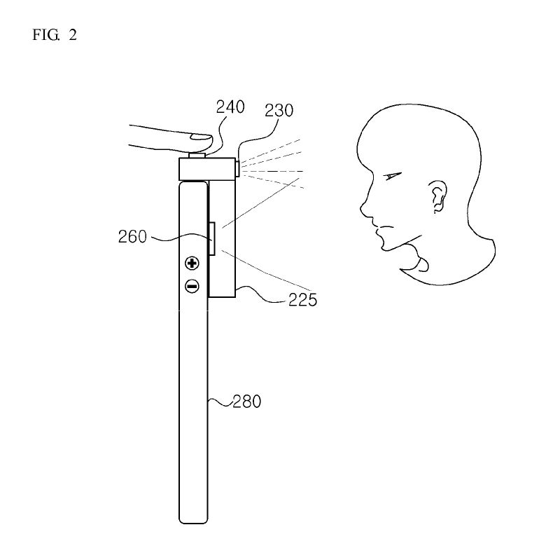

FIG. 2 is a schematic diagram illustrating a case in which the electronic device coupled with the self-defense spray according to the exemplary embodiment of the present invention is operated. FIG. 2 illustrates that a criminal approaches a user of a self-defense spray, and the user uses the self-defense spray coupled with an electronic device 280 toward the criminal. In response to a button 240 pressed by a finger of the user, a liquid material is sprayed toward the criminal through a nozzle 230. Simultaneously, an electric signal is transferred to the electronic device 280 through the button 240 to operate a camera 260. The nozzle 230 and the camera 260 face in the same direction. Therefore, when the user sprays the liquid material toward the criminal, the camera 260 may accurately photograph a face of the criminal

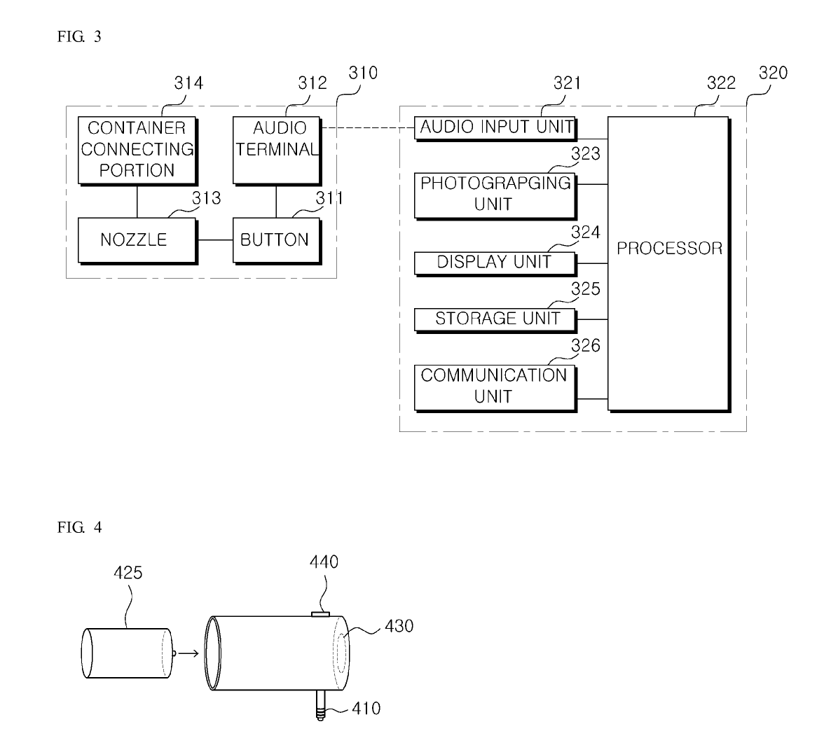

FIG. 3 is a block diagram of the self-defense spray and the electronic device according to the exemplary embodiment of the present invention. A self-defense spray 310 includes a button 311, an audio terminal 312, a nozzle 313, and a container connecting portion 312. An electronic device 320 includes an audio input unit 321, a processor 322, a photographing unit 323, a display unit 324, a storage unit 325, and a communication unit 326. The button 311, the audio terminal 312, the nozzle 313, and the container connecting portion 312 included in the self-defense spray 310 of FIG. 3 are substantially the same as the button 140, the audio terminal 110, the nozzle 130, and the container connecting portion 120 described with reference to FIG. 1A. Thus, repeated description is omitted.

In the block diagram of FIG. 3, the audio terminal 312 of the self-defense spray 310 is connected to the audio input unit 321 of the electronic device 320. In response to the button 311 pressed, the self-defense spray 310 transmits a predetermined signal, for example, a function signal to the audio input unit 321 of the electronic device 320 through the audio terminal 312. The audio input unit 321 receives the function signal from the audio terminal 312 of the self-defense spray 310, and transmits the function signal to the processor 322.

The processor 322 of the electronic device 320 may refer to a processor capable of performing various operations in the electronic device 320 such as a mobile phone, a smart phone, a notebook computer, a digital broadcasting terminal, PDA, a PMP, navigation equipment, and the like.

The processor 322 in the electronic device 320 that may be coupled with the self-defense spray 310 according to the exemplary embodiment of the present invention causes a camera to take a photograph in response to a function signal from the self-defense spray 310. Even when the electronic device 320 is in a standby state or an idle state, the processor 322 causes the camera to take a photograph in response to a function signal from the self-defense spray 310. The processor 322 may be configured to be authorized to cause the camera to take a photograph in a standby state or idle state in a system of the electronic device 320. It is a characteristic requested from the self-defense spray 310 to operate so that the processor 322 is authorized to cause the camera to take a photograph in a standby state or idle state of the electronic device 320. The electronic device 320 connectable to the self-defense spray 310 according to the exemplary embodiment of the present invention may take a photograph by an input of the button 311 without a user releasing a standby state or an idle state to take a photograph when a criminal approaches. Therefore, it is possible to combat crime in an urgent crisis.

Further, the processor 322 may store a taken photograph in the storage unit 325, transmit a stored photograph through the communication unit 326, transmit a state and location information of a user to a network of emergency contacts through the communication unit 326, and output a sound through an output unit.

The photographing unit 323 takes a photograph to acquire an image of a targeted criminal. The photographing unit 323 includes a camera lens and an image sensor such as a charge coupled device (CCD) or a complementary metal oxide semiconductor (CMOS). The photographing unit 323 detects an image of a criminal through a lens by the image sensor. The photographing unit 323 converts a signal from the image sensor to a digital signal, and to an image signal, and may store the image signal in a memory. An image from the photographing unit 323 in the specification refers to an image signal converted to a digital signal. The photographing unit 323 may additionally include an infrared ray cut-off filter, an anti-aliasing filter, and the like.

In addition, the photographing unit 323 includes a flash. For example, the photographing unit 323 includes a light emitting diode (LED) flash, and may obstruct a criminal by operating an LED in response to the button 311 pressed.

The display unit 324 is a display device including a liquid crystal display (LCD), an organic light emitting display (OLED), and the like, and displays an operation associated with the self-defense spray 310, a usage, or the like. In addition, when the electronic device 320 includes a touch screen display, the display unit 324 may perform a function of an input unit. For example, the display unit 324 may display an indication about whether to contact a network of emergency contacts in response to the button 311 pressed. Depending on a setting, a connection to the network of emergency contacts may be automatically performed. The display unit 324 may be implemented in various forms and schemes within a scope capable of achieving an object of the invention in addition to the above description.

The storage unit 325 in the electronic device 320 according to the exemplary embodiment of the present invention stores at least an application for causing the camera to take a photograph in response to the button 311 of the self-defense spray 310 pressed. The storage unit 325 functions as a storage means of electronic information such as an electrically erasable programmable read-only memory (EEPROM) and a flash memory.

The communication unit 326 includes a radio communication unit 326, and transmits and receives various types of information to and from an external server using the radio communication unit 326. The electronic device 320 may send a text message to a network of emergency contacts, transmit a taken photograph, or connect a telephone call using a network such as a third generation (3G) network and a fourth generation (4G) network. Furthermore, the electronic device 320 may transceive location information, a photograph of a criminal, and the like through a wireless local area network (WLAN) communication network.

FIG. 4 is a schematic diagram illustrating a self-defense spray according to another exemplary embodiment of the present invention, and a container coupled with the self-defense spray.

FIG. 4 illustrates an audio terminal 410, a nozzle 430, a button 440, and a container 425. An aspect of FIG. 4 is an aspect of a self-defense spray including another housing other than a housing that forms the nozzle 430 and a photographing unit of an electronic device in the same direction when being connected to the electronic device. Even when the electronic device and the self-defense spray are connected to each other through the audio terminal 410, a direction of the audio terminal 410 may be adjusted according to an intention of a user in FIG. 4. In the aspect, a user may more accurately spray a liquid material on a criminal.

FIG. 5 is a schematic diagram illustrating that an electronic device using a self-defense spray according to various exemplary embodiments of the present invention performs various functions through a communication network. FIG. 5 illustrates an electronic device 510 coupled with a self-defense spray, a communication network 520, a mobile phone of a network of emergency contacts 530, and a server 540. The electronic device 510 of FIG. 5 is substantially the same as the electronic device 310 of FIG. 3. Thus, repeated description is omitted.

The electronic device 510 may wirelessly communicate with the mobile phone of a network of emergency contacts 530, the server 540, and the like through the communication network 520. The communication network 520 may be a high speed backbone network of a large communication network that may provide a mass storage, a long-distance voice, and a data service, and may be a next generation wired and wireless network for providing the Internet or a high speed multimedia service. When the communication network 520 corresponds to a mobile communication network, the communication network 520 may be a synchronous mobile network, and may be an asynchronous mobile network. A communication network of a wideband code division multiple access (WCDMA) scheme may be an example of the asynchronous mobile network. Although not illustrated, the mobile communication network may include a radio network controller (RNC) when the WCDMA scheme is used. On the other hand, even though a WCDMA network is described as an example of the communication network 520, the communication network 520 may be a next generation communication network such as a 3G network, a long-term evolution (LTE) network, a 4G network, and the like, and an Internet protocol (IP) network based on an IP.

Further, the communication network 520 may be a WLAN. The WLAN is a technology enabling a user to wirelessly access the Internet in a home, a company, or a particular service providing area using an external device such as a laptop computer, a navigation device, a smart phone, and the like based on a radio frequency technology.

The mobile phone of a network of emergency contacts 530 is the mobile phone of a network of emergency contacts 530 set in advance when the self-defense spray is pressed. In response to the self-defense spray pressed, a text message may be sent or a call may be connected to the mobile phone of a network of emergency contacts 530. Herein, the text message sent to the mobile phone of a network of emergency contacts 530 may include information of a location where the self-defense spray is used by a user, and information of a time when the self-defense spray is used by a user, and the like.

The server 540 is a server for various systems associated with the self-defense spray. The server 540 may be a server managed by police. Further, the server 540 may be a server of a service provider associated with the self-defense spray. When the server 540 is a server of a service provider associated with the self-defense spray, various types of information associated with an operation of a service, a registration of a user, authentication information for an authentication of the electronic device 510 are managed.

The server of a service provider provides data and a related program requested to use a system. Data and a related program requested to use a system may include a webpage, an application for a smart phone, customized programs, and the like.

When the self-defense spray is used, various types of information may be collected. For example, information of a location where the self-defense spray is used may be acquired through a global positioning system (GPS), or other location collecting means. In addition, a photograph of a criminal is acquired. Further, a time when the self-defense spray is used is stored. Information associated with a use of the self-defense spray may be transmitted to the server of a service provider through the communication network 520 from the electronic device 510.

The server of a service provider manages transceived information about using the self-defense spray, and provides collected information. The server of a service provider may collect information about using the self-defense spray from a plurality of electronic devices 510, and use the information in various schemes. The server of a service provider may include a database that manages collected information.

For example, the server of a service provider may map information of a location where the self-defense spray is used on a map, and provide the map to users. The location where the self-defense spray is used may be perceived a sex crime-ridden district. In addition, a time when the self-defense spray is used may be collected to extract a time period at which sex crime frequently occurs. Based on the information, it is possible to send a text message or provide a push alarm to warn a user when the user moves to a predetermined location or moves to a predetermined location at a predetermined time.

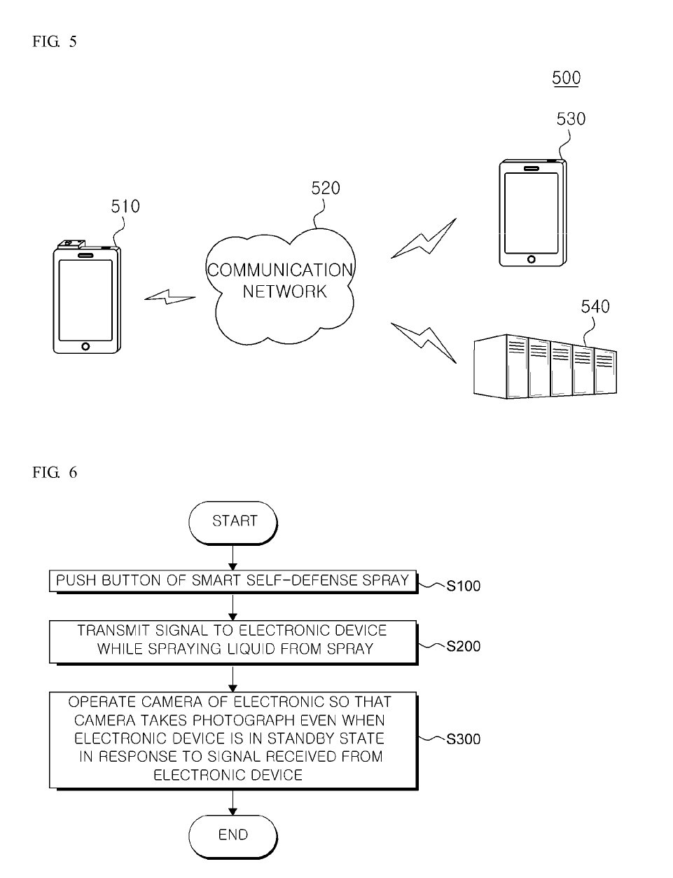

FIG. 6 is a flowchart illustrating a method of controlling the electronic device using the self-defense spray according to the exemplary embodiment of the present invention

First, in S100, a button of the self-defense spray is pressed. The button generates an electric signal, and transfers a physical force to spray a liquid material through a nozzle.

In S200, a signal generated in the button of the self-defense spray is transmitted to the electronic device while a liquid material from a container of the self-defense spray is sprayed on a criminal.

In S300, a camera is operated in the electronic device so that the camera takes a photograph even when the electronic device is in a standby state in response to a signal received from the self-defense spray. In addition, information indicating that the self-defense spray is used may be transmitted to a mobile phone set in advance in a network of emergency contacts. Further, a photograph taken by the camera, information of a location where the self-defense spray is used, and information of a time when the self-defense spray is used may be transmitted to a server through a communication network, and be used in various schemes described above to help reduce sex crime rate.

Combinations of each block of the accompanying block diagram and each step of the flow chart can be implemented by algorithms or computer program instructions comprised of firmware, software, or hardware. Since these algorithms or computer program instructions can be installed in processor of a universal computer, a special computer or other programmable data processing equipment, the instructions executed through a processor of a computer or other programmable data processing equipment generates means for implementing functions described in each block of the block diagram or each step of the flow chart. Since the algorithms or computer program instructions can be stored in a computer available or computer readable memory capable of orienting a computer or other programmable data processing equipment to implement functions in a specific scheme, the instructions stored in the computer available or computer readable memory can produce items involving an instruction means executing functions described in each block of the block diagram or each step of the flow chart. Since the computer program instructions can be installed in a computer or other programmable data processing equipment, a series of operation steps are carried out in the computer or other programmable data processing equipment to create a process executed by the computer such that instructions implementing the computer or other programmable data processing equipment can provide steps for implementing functions described in functions described in each block of the block diagram or each step of the flow chart.

Further, each block or each step may indicate a part of a module, a segment, or a code including one or more executable instructions for implementing specific logical function(s). Furthermore, it should be noted that in some alternative embodiments, functions described in blocks or steps can be generated out of the order. For example, two blocks or steps illustrated continuously may be implemented simultaneously, or the blocks or steps may be implemented in reverse order according to corresponding functions.

The exemplary embodiments of the present invention have been described in more detail with reference to the accompanying drawings, but the present invention is not limited to the exemplary embodiments. It will be apparent to those skilled in the art that various modifications can be made without departing from the technical sprit of the invention. Accordingly, the exemplary embodiments disclosed in the present invention are used not to limit but to describe the technical spirit of the present invention, and the technical spirit of the present invention is not limited to the exemplary embodiments. Therefore, the exemplary embodiments described above are considered in all respects to be illustrative and not restrictive. The protection scope of the present invention must be interpreted by the appended claims and it should be interpreted that all technical spirits within a scope equivalent thereto are included in the appended claims of the present invention.

What is claimed is:

1. A self-defense spray comprising:
an audio terminal connectable to the electronic device configured to transmit at least one signal to an electronic device capable of taking a photograph,
a connecting portion configured to connect to a container storing a liquid;
a nozzle configured to spray a liquid material from the container; and
a button, when triggered, configured to simultaneously control the nozzle to spray the liquid material, and transmit a signal for taking a photograph to the electronic device through the audio terminal

2. The self-defense spray according to claim 1, wherein the button is positioned on an opposite side of the audio terminal.

3. The self-defense spray according to claim 1, further comprising
a housing configured to allow a spray direction of the nozzle to match a direction in which the electronic device takes a photograph.

4. The self-defense spray according to claim 1, wherein the at least one signal is a function channel signal.

5. The self-defense spray according to claim 1, further comprising
an input terminal configured to connect a separate audio terminal to the electronic device.

6. A method of controlling an electronic device connected to a self-defense spray, and including a camera, the method comprising:
receiving a function signal through an audio terminal of the self-defense spray; and
operating the camera such that the camera takes a photograph in response to the function signal,
wherein the operating of the camera is performed even when the electronic device is in a standby state.

7. The method according to claim 6, further comprising
transmitting information indicating that the operation of the self-defense spray, to emergency contacts in response to the signal, while operating the camera.

8. The method according to claim 6, further comprising
transmitting the taken photograph to emergency contacts.

9. The method according to claim 6, further comprising
transmitting, to a server, the photograph, information of a location where the photograph is taken, and information of a time when the photograph is taken.
